(19) United States
(12) Patent Application Publication
(10) Pub. No.: US 2024/0248382 A1
(43) Pub. Date: Jul. 25, 2024

(54) LASER PROJECTION APPARATUS

(71) Applicant: HISENSE LASER DISPLAY CO., LTD, Qingdao (CN)

(72) Inventors: Lihaonan LUO, Qingdao (CN); Wei LI, Qingdao (CN)

(73) Assignee: HISENSE LASER DISPLAY CO., LTD, Qingdao (CN)

(21) Appl. No.: 18/424,233

(22) Filed: Jan. 26, 2024

Related U.S. Application Data
(63) Continuation of application No. PCT/CN2022/101529, filed on Jun. 27, 2022.

(30) Foreign Application Priority Data
Jul. 30, 2021 (CN) 202110875070.1
Jul. 30, 2021 (CN) 202121778764.5

(51) Int. Cl. G03B 21/20; G03B 33/12

(52) U.S. Cl. CPC G03B 21/2033; G03B 21/2013; G03B 21/2066; G03B 21/2073; G03B 33/12

(57) ABSTRACT

A laser projection apparatus includes a laser source, a light modulation assembly, and a projection lens. The laser source includes a laser device, a combining lens group, and a polarization conversion component. The combining lens group is located on a laser-exit side of the laser device and configured to combine laser beams of different colors emitted by a light-emitting group to a same position and propagate the combined laser beam in a preset direction. The polarization conversion component is configured to change a polarization direction of a portion of the laser beam of at least one color. The light modulation assembly includes a fly-eye lens group. The fly-eye lens group is located on a laser-exit side of the laser source and configured to homogenize the incident laser beam.

### CROSS-REFERENCE TO RELATED APPLICATIONS

This application is a continuation application of International Patent Application No. PCT/CN2022/101529, filed on Jun. 27, 2022, which claims priority to Chinese Patent Application No. 202110875070.1, filed on Jul. 30, 2021, and Chinese Patent Application No. 202121778764.5, filed on Jul. 30, 2021, which are incorporated herein by reference in their entireties.

### TECHNICAL FIELD

The present disclosure relates to the field of laser projection technologies and, in particular, to a laser projection apparatus.

### BACKGROUND

Laser projection technologies are developing rapidly. As a core component of a laser projection apparatus, a laser device plays an important role in the laser projection apparatus. Multi-chip lasers (MCL) occupy small space and are conducive to miniaturization of laser sources. Moreover, an MCL further has advantages such as long service life, high luminance, and high power. Functions of a plurality of mono-color laser devices may be achieved by encapsulating laser chips emitting laser beams of different colors in a same MCL.

### SUMMARY

A laser projection apparatus is provided. The laser projection apparatus includes a laser source, a light modulation assembly, and a projection lens. The laser source includes a laser device, a combining lens group, and a polarization conversion component. The laser device includes a plurality of first light-emitting components, a plurality of second light-emitting components, and a plurality of third light-emitting components. The plurality of first light-emitting components are configured to emit a first laser beam. The plurality of second light-emitting components are configured to emit a second laser beam. The plurality of third light-emitting components are configured to emit a third laser beam. The plurality of first light-emitting components, the plurality of second light-emitting components, and the plurality of third light-emitting components each are arranged in an array, so as to provide a light-emitting group. The combining lens group is located on a laser-exit side of the laser device. The combining lens group is configured to combine the laser beams of different colors emitted by the light-emitting group to a same position and propagate the combined laser beam in a preset direction. The polarization conversion component is located on the laser-exit side of the laser device and configured to change a polarization direction of a portion of the laser beam of at least one color, so that the laser beam of the at least one color has different polarization directions. The light modulation assembly is configured to modulate the illumination beams with image signals, so as to obtain projection beams. The light modulation assembly includes a fly-eye lens group and a light modulation device. The fly-eye lens group is located on a laser-exit side of the laser source and configured to homogenize the incident laser beam. The light modulation device is configured to modulate the illumination beams to obtain the projection beams. The projection lens is configured to project the projection beams into an image.

### BRIEF DESCRIPTION OF THE DRAWINGS

In order to describe the technical solutions in the present disclosure more clearly, accompanying drawings to be used in some embodiments of the present disclosure will be introduced briefly below. However, the accompanying drawings to be described below are merely accompanying drawings of some embodiments of the present disclosure, and a person of ordinary skill in the art may obtain other drawings according to these drawings. In addition, the accompanying drawings to be described below may be regarded as schematic diagrams but are not limitations on an actual size of a product, an actual process of a method and an actual timing of a signal involved in the embodiments of the present disclosure.

FIG. 1 is a diagram showing a structure of a laser projection apparatus, in accordance with some embodiments;

FIG. 2 is a diagram showing a partial structure of a laser projection apparatus, in accordance with some embodiments;

FIG. 3 is a timing diagram of a laser source in a laser projection apparatus, in accordance with some embodiments;

FIG. 4 is a diagram showing a beam path of a laser source, a light modulation assembly, and a projection lens in a laser projection apparatus, in accordance with some embodiments;

FIG. 5 is a diagram showing a structure of a laser device, in accordance with some embodiments;

FIG. 6 is a diagram showing a beam path of a laser source, in accordance with some embodiments;

FIG. 7 is a diagram showing a structure of another laser device, in accordance with some embodiments;

FIG. 8 is a diagram showing a structure of yet another laser device, in accordance with some embodiments;

FIG. 9 is a diagram showing a beam path of a laser source corresponding to the laser device shown in FIG. 7;

FIG. 10 is a diagram showing a beam path of another laser source corresponding to the laser device shown in FIG. 7;

FIG. 11 is a diagram showing a beam path of a laser source corresponding to the laser device shown in FIG. 8; and

FIG. 12 is a diagram showing a beam path of another laser source corresponding to the laser device shown in FIG. 8.

### DETAILED DESCRIPTION

Some embodiments of the present disclosure will be clearly and completely described below with reference to the accompanying drawings. However, the described embodiments are merely some but not all embodiments of the present disclosure. All other embodiments obtained by a person of ordinary skill in the art based on embodiments of the present disclosure shall be included in the protection scope of the present disclosure.

Unless the context requires otherwise, throughout the specification and the claims, the term “comprise” and other forms thereof such as the third-person singular form “comprises” and the present participle form “comprising” are construed as an open and inclusive meaning, i.e., “including, but not limited to.” In the description of the specification, the terms such as “one embodiment,” “some embodiments,” “exemplary embodiments,” “example,” “specific example,” or “some examples” are intended to indicate that specific features, structures, materials, or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics may be included in any one or more embodiments or examples in any suitable manner.

Hereinafter, the terms such as “first” and “second” are used for descriptive purposes only and are not to be construed as indicating or implying the relative importance or implicitly indicating the number of indicated technical features. Thus, features defined by “first” or “second” may explicitly or implicitly include one or more of the features. In the description of the embodiments of the present disclosure, the term “a plurality of” or “the plurality of” means two or more unless otherwise specified.

In the description of some embodiments, the term “connected,” and derivative thereof may be used. The term “connected” should be understood in a broad sense. For example, the term “connected” may represent a fixed connection, a detachable connection, or a one-piece connection, or may represent a direct connection, or may represent an indirect connection through an intermediate medium. The embodiments disclosed herein are not necessarily limited to the content herein.

The phrase “at least one of A, B, and C” has the same meaning as the phrase “at least one of A, B, or C,” both including the following combinations of A, B, and C: only A, only B, only C, a combination of A and B, a combination of A and C, a combination of B and C, and a combination of A, B, and C.

The use of the phase “applicable to” or “configured to” herein means an open and inclusive expression, which does not exclude devices that are applicable to or configured to perform additional tasks or steps.

The term such as “about,” “substantially,” and “approximately” as used herein includes a stated value and an average value within an acceptable range of deviation of a particular value. The acceptable range of deviation is determined by a person of ordinary skill in the art, considering measurement in question and errors associated with measurement of a particular quantity (i.e., limitations of a measurement system).

The term such as “parallel,” “perpendicular,” or “equal” as used herein includes a stated condition and a condition similar to the stated condition. A range of the similar condition is within an acceptable deviation range, and the acceptable deviation range is determined by a person of ordinary skill in the art, considering measurement in question and errors associated with measurement of a particular quantity (i.e., the limitations of a measurement system).

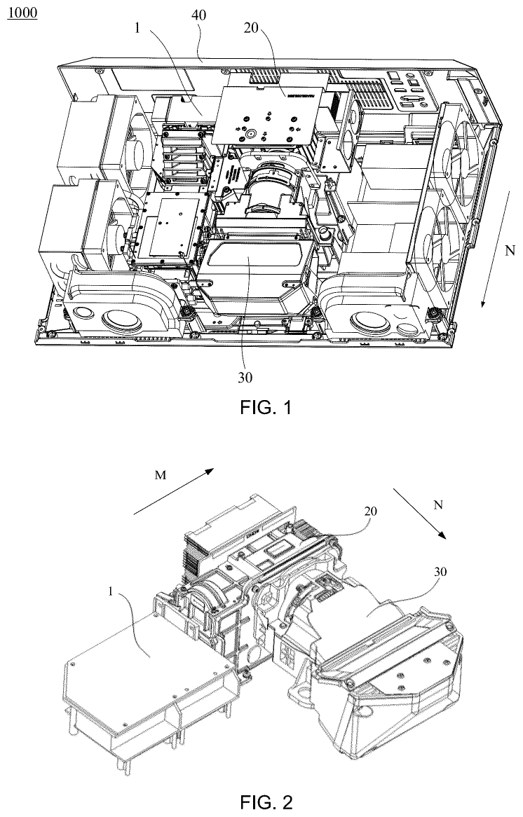

FIG. 1 is a diagram showing a structure of a laser projection apparatus, in accordance with some embodiments. FIG. 2 is a diagram showing a partial structure of a laser projection apparatus, in accordance with some embodiments.

In some embodiments of the present disclosure, a laser projection apparatus is provided. As shown in FIG. 1, the laser projection apparatus 1000 includes an apparatus housing 40 (only a portion of the apparatus housing 40 being shown in FIG. 1), and a laser source 1, a light modulation assembly 20, and a projection lens 30 assembled in the apparatus housing 40. The laser source 1 is configured to provide illumination beams. The light modulation assembly 20 is configured to modulate the illumination beams provided by the laser source 1 with image signals, so as to obtain projection beams. The projection lens 30 is configured to project the projection beams into an image on a screen or a wall.

The laser source 1, the light modulation assembly 20, and the projection lens 30 are sequentially connected in a propagation direction of the beams, and each is housed by a corresponding housing. The housings of the laser source 1, the light modulation assembly 20, and the projection lens 30 support their corresponding optical components, respectively, and make the optical components meet certain sealing or airtight requirements.

As shown in FIG. 2, an end of the light modulation assembly 20 is connected to the laser source 1, and the laser source 1 and the light modulation assembly 20 are arranged in an exit direction (referring to the direction M shown in FIG. 2) of the illumination beams of the laser projection apparatus 1000. Another end of the light modulation assembly 20 is connected to the projection lens 30, and the light modulation assembly 20 and the projection lens 30 are arranged in an exit direction (referring to the direction N shown in FIG. 2) of the projection beams of the laser projection apparatus 1000. The exit direction M of the illumination beams is substantially perpendicular to the exit direction N of the projection beams. In one aspect, such a connection structure may adapt to characteristics of a beam path of a reflective light valve in the light modulation assembly 20, and in another aspect, it is also conducive to shortening a length of a beam path in a one-dimensional direction, which is helpful for structural arrangement of the laser projection apparatus 1000. For example, in a case where the laser source 1, the light modulation assembly 20, and the projection lens 30 are disposed in the one-dimensional direction (e.g., the direction M), a length of a beam path in the one-dimensional direction is long, which is not conducive to the structural arrangement of the laser projection apparatus 1000. The reflective light valve will be described below.

In some embodiments, the laser source 1 may sequentially provide beams of three primary colors (beams of other colors may also be added on a basis of the beams of three primary colors). However, due to a phenomenon of visual perception of human eyes, what the human eyes see is white beams formed by mixing the beams of three primary colors. Alternatively, the laser source 1 may also simultaneously output the beams of three primary colors, so as to continuously emit white beams. The laser source 1 includes a laser device that may emit a laser beam of at least one color, such as a blue laser beam. In some embodiments of the present disclosure, the laser source 1 includes a laser device emitting laser beams of three colors: red, green, and blue, and sequentially outputs the laser beams of three colors.

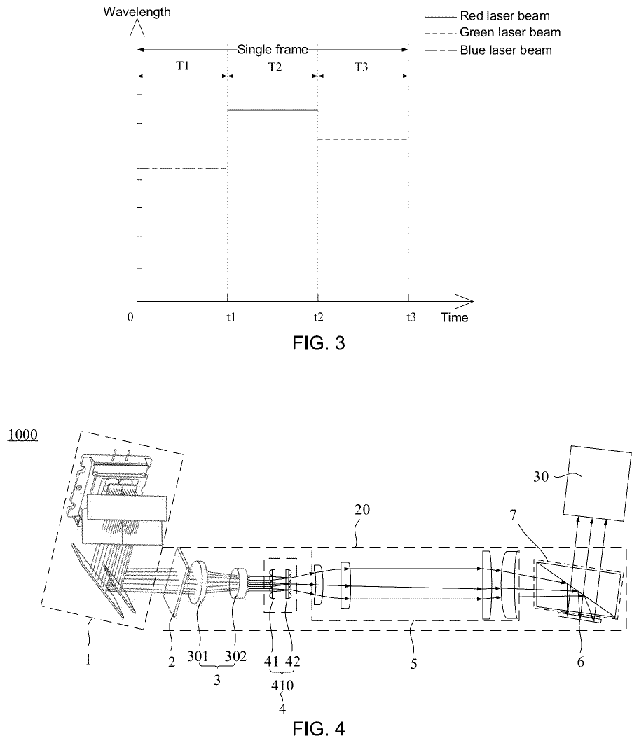

FIG. 3 is a timing diagram of a laser source in a laser projection apparatus, in accordance with some embodiments.

For example, as shown in FIG. 3, during a projection process of a frame of a target image, the laser source 1 sequentially outputs blue laser beams, red laser beams, and green laser beams. The laser source 1 outputs the blue laser beams in a first period T1, the red laser beams in a second period T2, and the green laser beams in a third period T3. Time for the laser source 1 to accomplish the sequential output of each of three primary color beams once is a cycle for the laser source 1 to output the three primary color beams. In a display cycle of the frame of the target image, the laser source 1 performs the sequential output of each of three primary color beams once. Therefore, the display cycle of the frame of the target image and the cycle for the laser source 1 to output the three primary color beams are equal to each other and both equal to a sum of the first period T1, the second period T2, and the third period T3. Due to a phenomenon of visual perception of human eyes, the human eyes will superimpose the colors of the blue laser beams, the red laser beams, and the green laser beams that are sequentially output. Therefore, what the human eyes see is white beams formed by combining the beams of three primary colors. The example is used for a non-overlapping timing of three primary color beams.

FIG. 4 is a schematic diagram of a beam path of a laser projection apparatus in accordance with some embodiments. The beam path includes a laser source 1, a light homogenizing component 20, and a projection lens 30.

The illumination beams emitted by the laser source 1 enter the light modulation assembly 20. Referring to FIG. 4, the light modulation assembly 20 includes a first light homogenizing component 2, a beam shaping assembly 3, a second light homogenizing component 4, a lens assembly 5, a digital micromirror device (DMD) 6, and a prism assembly 7.

The first light homogenizing component 2 is located on a laser-exit side of the laser source 1 and configured to homogenize and diffuse the illumination beams from the laser source 1. The beam shaping component 3 is located on a laser-exit side of the first light homogenizing component 2 and configured to converge the illumination beams diffused by the first light homogenizing component 2. The second light homogenizing component 4 is located on a laser-exit side of the beam shaping component 3 and configured to homogenize the illumination beams converged by the beam shaping component 3. The lens assembly 5 is located on a laser-exit side of the second light homogenizing component 4 and configured to propagate the illumination beams to the prism assembly 7. The prism assembly 7 reflects the illumination beams onto the digital micromirror device 6. The digital micromirror device 6 modulates the illumination beams to obtain the projection beams and reflects the modulated projection beams into the projection lens 30.

In some embodiments, the first light homogenizing component 2 may be a diffusion plate or a fly-eye lens group.

In some embodiments, as shown in FIG. 4, the beam shaping component 3 may include a convex lens 301 and a concave lens 302. The convex lens 301 and the concave lens 302 are sequentially arranged in the propagation direction of the beams, and the convex lens 301 is closer to the first light homogenizing component 2 than the concave lens 302. The convex lens 301 and the concave lens 302 constitute a Galileo telescope.

However, the present disclosure is not limited thereto. In some embodiments, the beam shaping component 3 may be a Kepler telescope. Alternatively, the beam shaping component 3 may include two convex lenses. One of the two convex lenses is configured to converge the laser beam to another convex lens. The another convex lens serves as a field lens, so as to reduce the divergence angle of the converged laser beam, thereby achieving beam contraction of the laser beam.

In some embodiments, as shown in FIG. 4, the second light homogenizing component 4 includes a fly-eye lens group 410. For example, the fly-eye lens group 410 includes a first fly-eye lens 41 and a second fly-eye lens 42 arranged opposite to each other in a propagation direction of the illumination beams. A laser-incident surface of the first fly-eye lens 41 and a laser-exit surface of the second fly-eye lens 42 each include micro lenses arranged in an array.

The illumination beams exiting from the laser source 1 are converged into multiple thin beams (i.e., laser beams with small beam spots) by different micro lenses on the laser-incident surface of the first fly-eye lens 41, and the multiple thin beams each are focused on a center of each micro lens of the second fly-eye lens 42. The plurality of micro lenses on the laser-exit surface of the second fly-eye lens 42 may diffuse the multiple thin beams, so that the multiple thin beams may become multiple wide beams (i.e., laser beams with big beam spots). The beam spots of the multiple wide beams overlap with each other. Therefore, the uniformity and luminance of the illumination beams are improved after the illumination beams pass through the first fly-eye lens 41 and the second fly-eye lens 42. The illumination beams passing through the fly-eye lens group 410 form an image on the digital micromirror device 6 after sequentially passing through lens assembly 5 and prism assembly 7.

In the light modulation assembly 20, the digital micromirror device 6 is configured to use an image signal to modulate the illumination beams provided by the laser source 1. That is to say, the digital micromirror device 6 controls the projection beams to display different luminance or gray scales according to different pixels in the image to be displayed, so as to finally produce a projection image. Therefore, the digital micromirror device 6 is also referred to as a light modulation device or a light valve. Depending on whether the light modulation device (or the light valve) transmits or reflects the illumination beams, the light modulation device may be classified as a transmissive light modulation device or a reflective light modulation device. For example, the digital micromirror device 6 shown in FIG. 4 reflects the illumination beams, and thus it is the reflective light modulation device. A liquid crystal light valve transmits the illumination beams, and thus it is the transmissive light modulation device.

In addition, according to a number of the light modulation devices used in the light modulation assembly 20, the light modulation assembly 20 may be classified as a single-chip system, a double-chip system, or a three-chip system. For example, only one digital micromirror device 6 is used in the light modulation assembly 20 shown in FIG. 4, and thus the light modulation assembly 20 may be referred to as the single-chip system. In a case where three digital micromirror devices 6 are used, the light modulation assembly 20 may be referred to as the three-chip system.

In a case where the light modulation assembly 20 is the three-chip system, the laser source 1 may simultaneously output the beams of three primary colors, so as to continuously emit the white beams.

It will be noted that, according to different projection architectures, the light modulation device may include various types, such as a liquid crystal on silicon (LCOS) or a digital micromirror device (DMD). Since the light modulation assembly 20 shown in FIG. 4 applies a digital light processing (DLP) projection architecture in some embodiments of the present disclosure, the light modulation device in some embodiments of the present disclosure is the digital micromirror device.

For ease of description, some embodiments of the present disclosure are mainly described by considering an example in which the laser projection apparatus 1000 adopts the DLP projection architecture, the light modulation device in the light modulation assembly 20 is the digital micromirror device 6. However, this should not be construed as a limitation on the present disclosure.

The laser source 1 according to some embodiments of the present disclosure will be described in detail below.

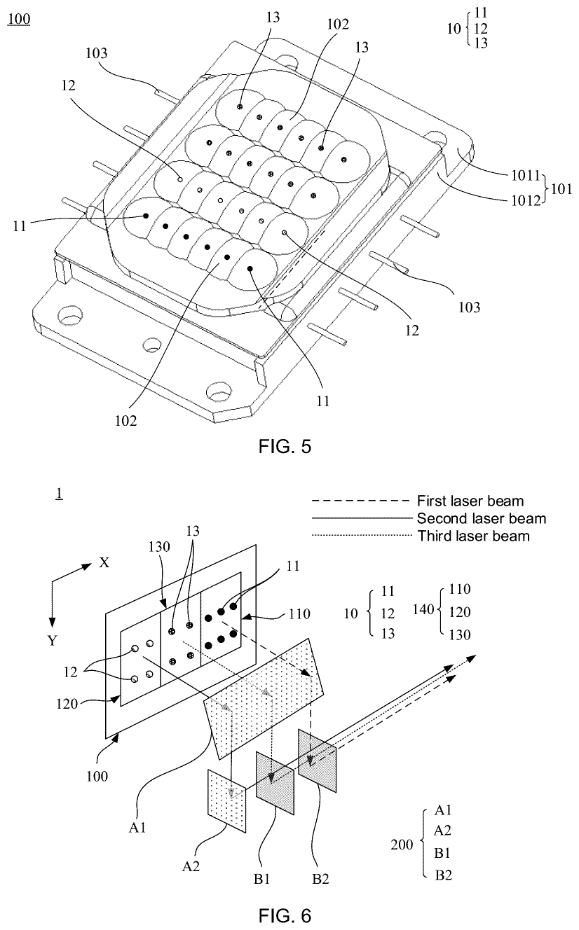

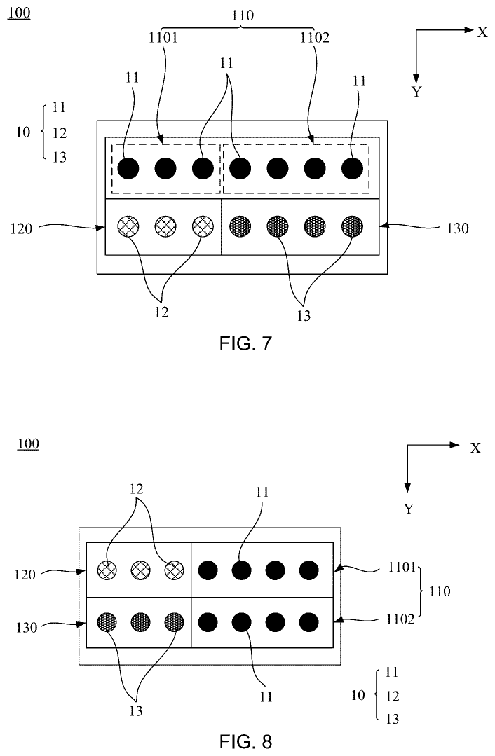

FIG. 5 is a diagram showing a structure of a laser device, in accordance with some embodiments. FIG. 6 is a diagram showing a beam path of a laser source, in accordance with some embodiments. FIG. 7 is a diagram showing a structure of another laser device, in accordance with some embodiments. FIG. 8 is a diagram showing a structure of yet another laser device, in accordance with some embodiments.

FIG. 5 shows a structure of a laser device utilized in the laser source 1. In FIG. 5, light-emitting components that emit the laser beams have been encapsulated inside the laser device, so that the specific structures of the light-emitting components are not shown in FIG. 5, and points like structures are used to show the light-emitting components. As shown in FIG. 5, the laser projection apparatus 1000 includes a laser device 100, and the laser device 100 is a multi-chip package laser device. For example, the laser device 100 includes a shell 101 and a plurality of light-emitting components 10. The shell 101 includes a base plate 1011 and a frame 1012 disposed on the base plate 1011, and the frame 1012 surrounds the plurality of light-emitting components 10. The plurality of light-emitting components 10 are arranged in an array and mounted on the base plate 1011, so as to form a surface laser source. The plurality of light-emitting components 10 may be connected in series with each other. Alternatively, the plurality of light-emitting components 10 may be connected in parallel in rows or columns.

In some embodiments, as shown in FIG. 5, the laser device 100 further includes a plurality of collimating lenses 102 located on laser-exit sides of the plurality of light-emitting components 10, respectively. For example, each light-emitting component 10 is located below the corresponding collimating lens 102. The plurality of collimating lenses 102 may be a one-piece member or separate piece members, and the present disclosure is not limited thereto.

In some embodiments, as shown in FIG. 5, the laser device 100 further includes a plurality of conductive pins 103, and the plurality of conductive pins 103 are configured to electrically connect the external power supply with the internal light-emitting components 10, so as to drive the plurality of light-emitting components 10 to emit laser beams. For example, the plurality of conductive pins 103 are disposed on two sides of the shell 101.

In some other embodiments, there is no need to provide the conductive pins 103 on the two sides of the shell 101. For example, the plurality of light-emitting components 10 are mounted on a metal base plate 1011 and in contact with a conductive pad on a driving circuit board by means of a conductive structure on the base plate 1011 or a conductive structure on the frame 1012, thereby achieving the electrical connection between the plurality of light-emitting components 10 and the external power supply.

In some embodiments, as shown in FIGS. 5 and 6, the plurality of light-emitting components 10 included by the laser device 100 are configured to emit laser beams of at least two colors.

For example, the laser device 100 includes a plurality of light-emitting components 10 arranged in multiple rows and columns, and the plurality of light-emitting components 10 may emit laser beams of three colors. A row of light-emitting components 10 may emit laser beams of a same color. Of course, a row of light-emitting components 10 may also include two or more light-emitting components 10 emitting laser beams of different colors.

In some examples, the plurality of light-emitting components 10 may also be arranged by rows or columns. For example, in some laser devices, the laser device includes a plurality of light-emitting components 10 arranged in different rows, and the numbers of light-emitting components 10 in adjacent rows are different from each other, so that the plurality of light-emitting components 10 do not form columns.

Moreover, FIG. 5 is used to show a case where the plurality of light-emitting components 10 are encapsulated within one shell 101. In some examples, the plurality of light-emitting components 10 are encapsulated in spaces enclosed by different shells 101. For example, the light-emitting components 10 emitting the red laser beams are located in the space enclosed by one shell 101, while the light-emitting components 10 emitting the blue laser beams and the light-emitting components 10 emitting the green laser beams are located in the space enclosed by another shell 101. In a case where the laser source 1 is operating, the light-emitting components 10 in the two shells 101 may be used as one laser device 100.

In some embodiments, as shown in FIGS. 6 to 8, the plurality of light-emitting components 10 include a plurality of first light-emitting components 11, a plurality of second light-emitting components 12, and a plurality of third light-emitting components 13. The plurality of first light-emitting components 11 are configured to emit a first laser beam, the plurality of second light-emitting components 12 are configured to emit a second laser beam, and the plurality of third light-emitting components 13 are configured to emit a third laser beam. The laser beams emitted by the first light-emitting components 11, the second light-emitting components 12, and the third light-emitting components 13 have different wavelengths.

The light-emitting components 10 emitting the laser beams of a same color are arranged in an array, so as to form a part of a light-emitting group 140. The plurality of light-emitting components 10 emitting the laser beams of different colors may form different parts of the light-emitting group 140. The plurality of light-emitting components 10 in the light-emitting group 140 are arranged in a matrix of M rows and N columns. Here, M and N are integers greater than or equal to 1, and at least one of M or N is greater than 1.

In some embodiments, the light-emitting group 140 includes a first light-emitting group 110, a second light-emitting group 120, and a third light-emitting group 130. For example, as shown in FIGS. 6 to 8, the plurality of first light-emitting components 11 are arranged in an array, so as to form the first light-emitting group 110, and the first light-emitting group 110 emits the first laser beams. The plurality of second light-emitting components 12 are arranged in an array, so as to form the second light-emitting group 120, and the second light-emitting group 120 emits the second laser beams. The plurality of third light-emitting components 13 are arranged in an array, so as to form the third light-emitting group 130, and the third light-emitting group 130 emits the third laser beams.

As shown in FIG. 6, in a case where the plurality of light-emitting components 10 are arranged in a 2×7 matrix, two or more light-emitting components 10 in the first light-emitting group 110 are arranged in a 2×3 matrix, two or more light-emitting components 10 in the second light-emitting group 120 are arranged in a 2×2 matrix, and two or more light-emitting components 10 in the third light-emitting group 130 are arranged in a 2×2 matrix. Here, the 2×7 matrix refers to a matrix arranged in two rows and seven columns. However, the plurality of light-emitting components 10 shown in FIG. 6 may also be arranged in a 4×6 matrix, a 3×5 matrix, or a 4×5 matrix. The laser devices 100 corresponding to the plurality of light-emitting components 10 arranged in different arrays have different luminous powers.

The following are given by considering an example in which the plurality of light-emitting components 10 in the laser device 100 are arranged in a 2×7 matrix and the plurality of light-emitting components 10 emit the laser beams of three different colors.

The plurality of light-emitting components 10 emitting laser beams of different colors may be encapsulated in one laser device 100. Therefore, one laser device 100 may emit laser beams of multiple colors, so that the laser device 100 may emit the laser beams of three primary colors. In addition, the laser beams emitted by the plurality of light-emitting components 10 may be approximately parallel light due to the good directionality of the laser beam emitted by the light-emitting component 10.

In some embodiments, the plurality of light-emitting components 10 may be laser chips. For example, the first light-emitting component 11, the second light-emitting component 12, and the third light-emitting component 13 are a red laser chip emitting a red laser beam, a green laser chip emitting a green laser beam, and a blue laser chip emitting a blue laser beam, respectively.

In some embodiments, as shown in FIG. 6, the laser source 1 further includes a combining lens group 200. The combining lens group 200 is located on a laser-exit side of the laser device 100 and configured to combine the laser beams of different colors emitted by the light-emitting group 140 to a same position and then propagate the combined laser beam in a same direction (i.e., a preset direction). It will be noted that combining the laser beams refers to adjusting multiple laser beams to substantially a same beam path.

For example, the combining lens group 200 includes a reflector and a combining lens (e.g., a dichroic mirror). The reflector is configured to reflect a laser beam, so as to change a beam path of the incident laser beam. The combining lens is configured to combine the laser beams of different colors. In this way, by providing the reflector and the combining lens, the laser beams of different colors emitted by the light-emitting group 140 may be combined to a same position, so that the beam spots of the laser beams of different colors overlap with each other, thereby reducing a size of an overlapping beam spot.

In some embodiments of the present disclosure, structures of the laser sources 1 corresponding to laser devices 100 in which the light-emitting components 10 are arranged differently will be described in detail below.

In some embodiments, as shown in FIG. 6, the second light-emitting group 120, the third light-emitting group 130, and the first light-emitting group 110 are sequentially arranged in a first direction X. The first direction X is a direction in which the rows of the array formed by the plurality of light-emitting components 10 are located.

In this case, as shown in FIG. 6, the combining lens group 200 includes a first reflector A1, a second reflector A2, a first combining lens B1, and a second combining lens B2.

The first reflector A1 is located on laser-exit sides of the first light-emitting group 110, the second light-emitting group 120, and the third light-emitting group 130, and configured to reflect the first laser beam emitted by the first light-emitting group 110, the second laser beam emitted by the second light-emitting group 120, and the third laser beam emitted by the third light-emitting group 130. The second reflector A2 is located on a laser-exit side of the first reflector A1 and configured to reflect the second laser beam.

The first combining lens B1 is located on a laser-exit side of the second reflector A2 and the laser-exit side of the first reflector A1 and configured to transmit the second laser beam and reflect the third laser beam. For example, the first combining lens B1 is located at an intersection of the laser beam exiting from the second reflector A2 and the laser beam exiting from the first reflector A1. The second combining lens B2 is located on a laser-exit side of the first combining lens B1 and the laser-exit side of the first reflector A1 and configured to transmit the second laser beam and the third laser beam and reflect the first laser beam. For example, the second combining lens B2 is located at an intersection of the laser beam exiting from the first combining lens B1 and the laser beam exiting from the first reflector A1. Moreover, the second reflector A2, the first combining lens B1, and the second combining lens B2 may be disposed parallel to each other.

In this way, as shown in FIG. 6, the laser beams emitted by the first light-emitting group 110, the second light-emitting group 120, and the third light-emitting group 130 are incident on the first reflector A1 and reflected by the first reflector A1.

The second laser beam emitted by the second light-emitting group 120 is reflected to the second reflector A2 by the first reflector A1 and then reflected to the first combining lens B1 by the second reflector A2. After being sequentially transmitted by the first combining lens B1 and the second combining lens B2, the second laser beam propagates to an outlet of the laser source 1.

After being reflected to the first combining lens B1 by the first reflector A1, the third laser beam emitted by the third light-emitting group 130 is reflected to the second combining lens B2 by the first combining lens B1 and transmitted to the outlet of the laser source 1 by the second combining lens B2.

The first laser beam emitted by the first light-emitting group 110 is reflected to the second combining lens B2 by the first reflector A1 and then reflected to the outlet of the laser source 1 by the second combining lens B2.

In this way, the combining lens group 200 may combine the first laser beam emitted by the first light-emitting group 110, the second laser beam emitted by the second light-emitting group 120, and the third laser beam emitted by the third light-emitting group 130 to a same position, so that the beam spots of the three laser beams may be approximately at a same position, thereby reducing the size of the beam spot formed by the three laser beams together. Moreover, the beam spot with a small size is conducive to matching with the second light homogenizing component 4 (referring to FIG. 4). That is to say, the size of the beam spot matches Etendue of the fly-eye lens group 410. In this way, it is possible to improve the light homogenizing effect of the second light homogenizing component 4 and the display effect of the laser projection apparatus 1000.

In some embodiments, the first light-emitting group 110 includes a first light-emitting sub-group 1101 and a second light-emitting sub-group 1102. As shown in FIG. 7, the first light-emitting sub-group 1101 and the second light-emitting sub-group 1102 are arranged in the first direction X. Alternatively, as shown in FIG. 8, the first light-emitting sub-group 1101 and the second light-emitting sub-group 1102 are arranged in a second direction Y. The second direction Y is a direction in which columns of the array formed by the plurality of light-emitting components 10 are located, and the second direction Y is perpendicular to the first direction X.

In some embodiments, as shown in FIG. 7, the first light-emitting sub-group 1101 and the second light-emitting sub-group 1102 are arranged in a row along the first direction X. The second light-emitting group 120 and the third light-emitting group 130 are arranged in another row along the first direction X. The first light-emitting sub-group 1101 and the second light-emitting group 120 are arranged in one or more columns along the second direction Y, while the second light-emitting sub-group 1102 and the third light-emitting group 130 are arranged in one or more columns along the second direction Y.

In some embodiments, as shown in FIG. 7, the number of rows of the array formed by the first light-emitting group 110 is equal to the number of rows of the array formed by the second light-emitting group 120 and the third light-emitting group 130, and the number of columns of the array formed by the first light-emitting group 110 is equal to the number of columns of the array formed by the second light-emitting group 120 and the third light-emitting group 130, so that the plurality of light-emitting components 10 may be arranged in a regular array.

However, in some embodiments, the number of columns of the array formed by the first light-emitting group 110 may also be greater than the number of columns of the array formed by the second light-emitting group 120 and the third light-emitting group 130, so that a length of the array formed by the first light-emitting group 110 in the first direction X (e.g., a row direction) is greater than a length of the array formed by the second light-emitting group 120 and the third light-emitting group 130 in the first direction X.

In some embodiments, in the first direction X, a length of a row of light-emitting components 10 formed by the first light-emitting group 110 is equal to a length of a row of light-emitting components 10 formed by the second light-emitting group 120 and the third light-emitting group 130. In this case, a distance between adjacent light-emitting components 10 in a row of light-emitting components 10 formed by the first light-emitting group 110 may be unequal to a distance between adjacent light-emitting components 10 in a row of light-emitting components 10 formed by the second light-emitting group 120 and the third light-emitting group 130.

In the encapsulating design process of the laser device 100, at least one of a distance between the plurality of light-emitting components 10 in the first light-emitting group 110 or a distance between the plurality of light-emitting components 10 in the second light-emitting group 120 and the third light-emitting group 130 may be adjusted, so that in the appearance contour, a length of a row of light-emitting components 10 formed by the first light-emitting group 110 and a length of a row of light-emitting components 10 formed by the second light-emitting group 120 and the third light-emitting group 130 are the same, which is convenient to encapsulating the light-emitting group 140 in one shell 110 with a rectangular shape. However, in some embodiments, different parts of the light-emitting group 140 may also be encapsulated in different shells 110 according to different row lengths. Here, the row length may refer to a length of a row of light-emitting components 10 in the first direction X.

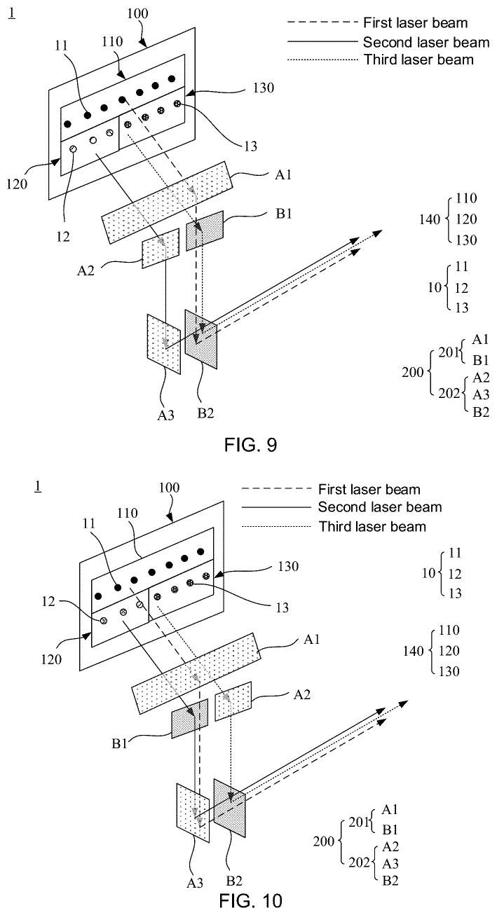

FIG. 9 is a diagram showing a beam path of a laser source corresponding to the laser device shown in FIG. 7.

In some embodiments, as shown in FIG. 9, the combining lens group 200 includes a first combining lens group 201 and a second combining lens group 202. The first combining lens group 201 includes a first reflector A1 and a first combining lens B1. The first combining lens group 201 is configured to combine the laser beams emitted by the first light-emitting group 110 and the third light-emitting group 130. The second combining lens group 202 includes a second reflector A2, a third reflector A3, and a second combining lens B2. The second combining lens group 202 is configured to combine the second laser beam emitted by the second light-emitting group 120 with the laser beam combined by the first combining lens group 201.

The first reflector A1 is located on the laser-exit side of the first light-emitting group 110 and configured to reflect the first laser beam. The second reflector A2 is located on the laser-exit side of the second light-emitting group 120 and configured to reflect the second laser beam. The third reflector A3 is located on the laser-exit side of the second reflector A2 and configured to reflect the second laser beam.

The first combining lens B1 is located on the laser-exit side of the third light-emitting group 130 and a laser-exit side of the first reflector A1 and configured to reflect the third laser beam and transmit the first laser beam. For example, the first combining lens B1 is located at an intersection of the laser beam exiting from the third light-emitting group 130 and the laser beam exiting from the first reflector A1. The second combining lens B2 is located on a laser-exit side of the first combining lens B1 and a laser-exit side of the third reflector A3 and configured to transmit the second laser beam and reflect the first laser beam and the third laser beam. For example, the second combining lens B2 is located at an intersection of the laser beam exiting from the first combining lens B1 and the laser beam exiting from the third reflector A3.

As shown in FIG. 9, the first laser beam emitted by the first light-emitting group 110 is reflected to the first combining lens B1 by the first reflector A1 after being incident on the first reflector A1 and then reflected to the outlet of the laser source 1 by the second combining lens B2 after being transmitted to the second combining lens B2 by the first combining lens B1.

The second laser beam emitted by the second light-emitting group 120 is reflected to the third reflector A3 by the second reflector A2 after being incident on the second reflector A2 and then transmitted to the outlet of the laser source 1 by the second combining lens B2 after being reflected to the second combining lens B2 by the third reflector A3.

The third laser beam emitted by the third light-emitting group 130 is reflected to the second combining lens B2 by the first combining lens B1 after being incident on the first combining lens B1 and then reflected to the outlet of the laser source 1 by the second combining lens B2.

Here, the first laser beam emitted by the first light-emitting group 110 and the third laser beam emitted by the third light-emitting group 130 are combined by the first combining lens B1, so that the beam spots of the two laser beams overlap with each other at a same position, thereby reducing an area of a beam spot formed by the first laser beam and the third laser beam. Moreover, the second laser beam emitted by the second light-emitting group 120 may be combined with the combined first laser beam and third laser beam by the second combining lens B2, so as to further reduce an area of a beam spot formed by the first laser beam, the second laser beam, and the third laser beam.

FIG. 10 is a diagram showing a beam path of another laser source corresponding to the laser device shown in FIG. 7.

In some embodiments, the position of the second reflector A2 and the position of the first combining lens B1 of the combining lens group 200 in FIG. 9 may be interchangeable. As shown in FIG. 10, the second reflector A2 is located on the laser-exit side of the third light-emitting group 130 and configured to reflect the third laser beam. The first combining lens B1 is located on the laser-exit side of the first reflector A1 and the laser-exit side of the second light-emitting group 120 and configured to transmit the first laser beam and reflect the second laser beam. For example, the first combining lens B1 is located at an intersection of the laser beam exiting from the first reflector A1 and the laser beam exiting from the second light-emitting group 120.

In this case, the third reflector A3 is configured to reflect the first laser beam and the second laser beam, and the second combining lens B2 is configured to transmit the first laser beam and the second laser beam, and reflect the third laser beam.

Moreover, the first combining lens group 201 is configured to combine the laser beams emitted by the first light-emitting group 110 and the second light-emitting group 120. The second combining lens group 202 is configured to combine the third laser beam emitted by the third light-emitting group 130 with the laser beam combined by the first combining lens group 201.

As shown in FIG. 10, the first laser beam emitted by the first light-emitting group 110 is reflected to the first combining lens B1 by the first reflector A1 after being incident on the first reflector A1 and then transmitted to the third reflector A3 by the first combining lens B1. The first laser beam incident on the third reflector A3 is reflected to the second combining lens B2 by the third reflector A3 and then transmitted to the outlet of the laser source 1 by the second combining lens B2.

The second laser beam emitted by the second light-emitting group 120 is reflected to the third reflector A3 by the first combining lens B1 after being incident on the first combining lens B1 and then transmitted to the outlet of the laser source 1 by the second combining lens B2 after being reflected to the second combining lens B2 by the third reflector A3.

The third laser beam emitted by the third light-emitting group 130 is reflected to the second combining lens B2 by the second reflector A2 after being incident on the second reflector A2 and then reflected to the outlet of the laser source 1 by the second combining lens B2.

Here, the first laser beam emitted by the first light-emitting group 110 and the second laser beam emitted by the second light-emitting group 120 are combined by the first combining lens B1, so that the beam spots of the two laser beams may overlap with each other at a same position, thereby reducing an area of a beam spot formed by the first laser beam and the second laser beam. Moreover, the third laser beam emitted by the third light-emitting group 130 may be combined with the combined first laser beam and second laser beam by the second combining lens B2, so as to further reduce an area of the beam spot formed by the first laser beam, the second laser beam, and the third laser beam.

In some embodiments of the present disclosure, the laser beams of different colors may be combined by combining laser beams of two colors and combining the combined laser beam with a laser beam of a third color. Compared to combining laser beams of three or more different colors at once, the manner of combining laser beams multiple times may make positions of the beam spots of laser beams of different colors approximately at a same position, so as to reduce the size of the beam spot formed by the laser beams of three colors and improve the accuracy of combining laser beams. Moreover, the laser source 1 may adapt to different numbers and arrangements of light-emitting components 10, so as to improve the coincidence degree of the beam spots of the laser beams of different colors.

However, the present disclosure is not limited thereto. In some embodiments, as shown in FIG. 8, the second light-emitting group 120 and the first light-emitting sub-group 1101 are arranged in a row along the first direction X. The third light-emitting group 130 and the second light-emitting sub-group 1102 are arranged in another row along the first direction X. The first light-emitting sub-group 1101 and the second light-emitting sub-group 1102 are arranged in one or more columns along the second direction Y. The second light-emitting group 120 and the third light-emitting group 130 are arranged in one or more columns along the second direction Y.

In some embodiments, as shown in FIG. 8, the number of rows in the array formed by the first light-emitting sub-group 1101 and the second light-emitting group 120 is equal to the number of rows in the array formed by the second light-emitting sub-group 1102 and the third light-emitting group 130, and the number of columns in the array formed by the first light-emitting sub-group 1101 and the second light-emitting group 120 is equal to the number of columns in the array formed by the second light-emitting sub-group 1102 and the third light-emitting group 130, so that the plurality of light-emitting components 10 may be arranged in a regular array.

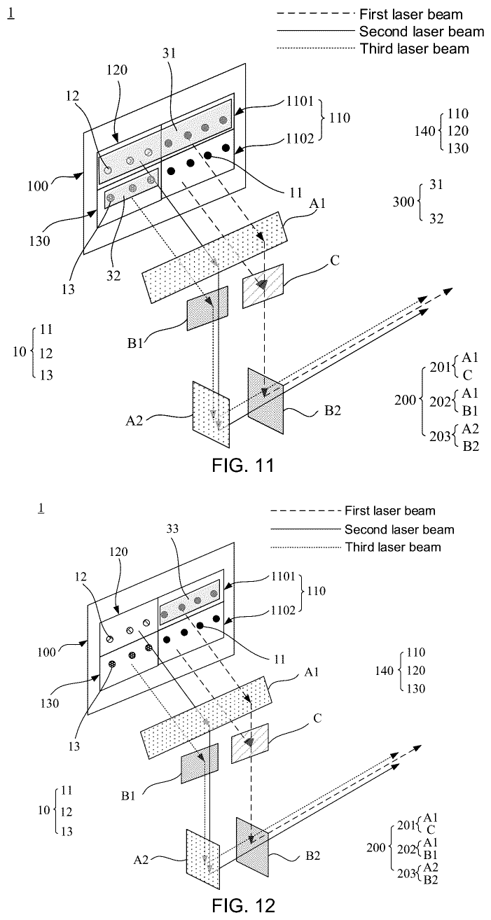

FIG. 11 is a diagram showing a beam path of a laser source corresponding to the laser device shown in FIG. 8.

In some embodiments, as shown in FIG. 11, the first laser beams emitted by the first light-emitting sub-group 1101 and the second light-emitting sub-group 1102 are first linearly polarized light, the second laser beam emitted by the second light-emitting group 120 and the third laser beam emitted by the third light-emitting group 130 are second linearly polarized light. Polarization directions of the first linearly polarized light and the second linearly polarized light are perpendicular to each other.

For example, the first linearly polarized light emitted by the first light-emitting sub-group 1101 and the second light-emitting sub-group 1102 is S-polarized light, and the second linearly polarized light emitted by the second light-emitting group 120 and the third light-emitting group 130 is P-polarized light. Alternatively, the first linearly polarized light emitted by the first light-emitting sub-group 1101 and the second light-emitting sub-group 1102 is P-polarized light, and the second linearly polarized light emitted by the second light-emitting group 120 and the third light-emitting group 130 is S-polarized light. P-polarized light refers to linearly polarized light with a polarization direction parallel to a laser-incident surface, and S-polarized light refers to linearly polarized light with a polarization direction perpendicular to the laser-incident surface.

Of course, the first laser beams emitted by the first light-emitting sub-group 1101 and the second light-emitting sub-group 1102 may also be the second linearly polarized light, and the second laser beam emitted by the second light-emitting group 120 and the third laser beam emitted by the third light-emitting group 130 may also be the first linearly polarized light, as long as a polarization direction of the first laser beam is perpendicular to a polarization direction of the second laser beam and the third laser beam.

In some embodiments, as shown in FIG. 11, the laser source 1 further includes a polarization conversion component 300. The polarization conversion component 300 is configured to change a polarization direction of a portion of a laser beam of at least one color, so that the laser beam of at least one color may have different polarization directions. The polarization conversion component 300 may be located on the laser-exit side of the laser device 100 (e.g., above a laser-exit surface of the laser device 100 or between the laser device 100 and the combining lens group 200) and perpendicular to a propagation path of the laser beam emitted by the laser device 100. The coherence of laser beams of a same color may be reduced by making the laser beam of at least one color have different polarization directions, which is conducive to reducing speckle phenomenon during projection imaging.

In some embodiments, the laser device 100 includes a light-emitting group 140 emitting laser beams of three colors, and the polarization conversion component 300 is configured to adjust a polarization direction of a portion of the laser beam emitted by the light-emitting group 140. For example, the polarization conversion component 300 is configured to adjust the polarization directions of a portion of the red laser beam, a portion of the green laser beam, and a portion of the blue laser beam, so that the polarization directions of the portion of the red laser beam, the portion of the green laser beam, and the portion of the blue laser beam may be different from the polarization directions of another portion of the red laser beam, another portion of the green laser beam, and another portion of the blue laser beam, respectively.

In some examples, the polarization conversion component 300 in FIG. 11 is a one-piece member. For example, the polarization conversion component 300 is a sheet structure. The sheet structure may be formed by coating different films in different regions or assembling different crystal structures. In this way, different coating regions or crystal structures each may form wave plate structures and correspond to the laser-exit surface of a laser beam of a corresponding color. For example, a coating region or crystal structure is located on the laser-exit side of the corresponding light-emitting group 140.

In some examples, the polarization conversion component 300 may also be separate members. For example, as shown in FIG. 11, the polarization conversion component 300 includes a first polarization conversion component 31 and a second polarization conversion component 32. The first polarization conversion component 31 is located on the laser-exit sides of the first light-emitting sub-group 1101 and the second light-emitting group 120 and configured to adjust a polarization direction of the incident laser beam, so that first linearly polarized light may be converted into the second linearly polarized light and the second linearly polarized light may be converted into the first linearly polarized light. The second polarization conversion component 32 is located on the laser-exit side of the third light-emitting group 130 and configured to adjust a polarization direction of the incident laser beam, so that the second linearly polarized light may be converted into the first linearly polarized light.

For example, the first linearly polarized light emitted by the first light-emitting sub-group 1101 is converted into the second linearly polarized light after passing through the first polarization conversion component 31. The second linearly polarized light emitted by the second light-emitting group 120 is converted into the first linearly polarized light after passing through the first polarization conversion component 31. The second linearly polarized light emitted by the third light-emitting group 130 is converted into the first linearly polarized light after passing through the second polarization conversion component 32.

In some embodiments, the first polarization conversion component 31 and the second polarization conversion component 32 may be a half-wave plate. The half-wave plate may change the polarization direction of the laser beam by 90°.

However, in some embodiments, the first polarization conversion component 31 and the second polarization conversion component 32 may also be quarter-wave plates, so as to achieve that a polarization direction of a portion of a laser beam is different from a polarization direction of the remaining portion of the laser beam.

In some embodiments, as shown in FIG. 11, the combining lens group 200 includes a first combining lens group 201, a second combining lens group 202, and a third combining lens group 203.

The first combining lens group 201 includes a first portion of a first reflector A1 and a polarization combining lens C. The first combining lens group 201 is configured to combine the first laser beams emitted by the first light-emitting sub-group 1101 and the second light-emitting sub-group 1102. The second combining lens group 202 includes a second portion of the first reflector A1 and a first combining lens B1. The second combining lens group 202 is configured to combine the laser beams emitted by the second light-emitting group 120 and the third light-emitting group 130. The third combining lens group 203 includes a second reflector A2 and a second combining lens B2, and the third combining lens group 203 is configured to combine the laser beam combined by the first combining lens group 201 with the laser beam combined by the second combining lens group 202. It will be noted that the first reflector A1 includes the first portion and the second portion.

The first reflector A1 is located on the laser-exit sides of the first light-emitting sub-group 1101 and the second light-emitting group 120 and configured to reflect the first laser beam and the second laser beam. For example, the first portion of the first reflector A1 is located on the laser-exit side of the first light-emitting sub-group 1101 and configured to reflect the first laser beam, and the second portion of the first reflector A1 is located on the laser-exit side of the second light-emitting group 120 and configured to reflect the second laser beam. The second reflector A2 is located on a laser-exit side of the first combining lens B1 and configured to reflect the second laser beam and the third laser beam.

The first combining lens B1 is located on the laser-exit side of the third light-emitting group 130 and a laser-exit side of the second portion of the first reflector A1 and configured to transmit the second laser beam and reflect the third laser beam. For example, the first combining lens B1 is located at an intersection of the laser beam exiting from the third light-emitting group 130 and the laser beam exiting from the second portion of the first reflector A1. The second combining lens B2 is located on a laser-exit side of the second reflector A2 and a laser-exit side of the polarization combining lens C and configured to transmit the second laser beam and the third laser beam and reflect the first laser beam. For example, the second combining lens B2 is located at an intersection of the laser beam exiting from the second reflector A2 and the laser beam exiting from the polarization combining lens C.

The polarization combining lens C is located on the laser-exit side of the second light-emitting sub-group 1102 and the laser-exit side of the first portion of the first reflector A1 and configured to transmit the second linearly polarized light and reflect the first linearly polarized light. For example, the polarization combining lens C is located at an intersection of the laser beam exiting from the second light-emitting sub-group 1102 and the laser beam exiting from the first portion of the first reflector A1.

In some embodiments, the polarization combining lens C may be a polarization beam splitter (PBS). Alternatively, the polarization combining lens C may be a lens coated with a polarization beam splitter dielectric film.

As shown in FIG. 11, the first laser beam (e.g., the first linearly polarized light) emitted by the first light-emitting sub-group 1101 is incident on the first polarization conversion component 31 and then incident on the first reflector A1 after being converted into the second linearly polarized light by the first polarization conversion component 31. The first laser beam (e.g., the second linearly polarized light) incident on the first reflector A1 is reflected to the polarization combining lens C by the first reflector A1 and then reflected to the outlet of the laser source 1 by the second combining lens B2 after being transmitted to the second combining lens B2 by the polarization combining lens C.

The first laser beam (e.g., the first linearly polarized light) emitted by the second light-emitting sub-group 1102 is reflected to the second combining lens B2 by the polarization combining lens C after being incident on the polarization combining lens C and then reflected to the outlet of the laser source 1 by the second combining lens B2.

Here, since the first laser beam emitted by the first light-emitting group 110 is divided into two laser beams (i.e., the first laser beam emitted by the first light-emitting sub-group 1101 and the first laser beam emitted by the second light-emitting sub-group 1102), the beam spot of the first laser beam has a large area. The beam spots of the two laser beams may overlap with each other at a same position by combining the first laser beam emitted by the first light-emitting sub-group 1101 and the first laser beam emitted by the second light-emitting sub-group 1102 by the polarization combining lens C, thereby reducing an area of a beam spot of the first laser beam emitted by the first light-emitting group 110.

The second laser beam (e.g., the second linearly polarized light) emitted by the second light-emitting group 120 is converted into the first linearly polarized light by the first polarization conversion component 31 and incident on the first reflector A1 after being incident on the first polarization conversion component 31. The second laser beam (e.g., the first linearly polarized light) incident on the first reflector A1 is transmitted to the second reflector A2 by the first combining lens B1 after being reflected to the first combining lens B1 by the first reflector A1 and then transmitted to the outlet of the laser source 1 by the second combining lens B2 after being reflected to the second combining lens B2 by the second reflector A2.

The third laser beam (e.g., the second linearly polarized light) emitted by the third light-emitting group 130 is converted into the first linearly polarized light by the second polarization conversion component 32 and incident on the first combining lens B1 after being incident on the second polarization conversion component 32. The third laser beam (e.g., the first linearly polarized light) incident on the first combining lens B1 is reflected to the second combining lens B2 by the second reflector A2 after being reflected to the second reflector A2 by the first combining lens B1 and then transmitted to the outlet of the laser source 1 by the second combining lens B2.

Here, the beam spots of the second laser beam and the third laser beam may overlap with each other at a same position after the second laser beam from the second light-emitting group 120 and the third laser beam from the third light-emitting group 130 are combined by the first combining lens B1, thereby reducing an area of a beam spot formed by the second laser beam and the third laser beam. Then, the combined second laser beam and third laser beam, along with the first laser beam combined by the polarization combining lens C, are incident on the second combining lens B2 and combined by the second combining lens B2, thereby reducing the area of the beam spot formed by the first laser beam, the second laser beam, and the third laser beam, and reducing the difference in the area of the beam spots of the laser beams of different colors, and improving the coincidence degree of the combined beam spot and the color uniformity of the combined beam spot.

In addition, there are differences in transmittance and reflectivity of optical lenses (e.g., the reflectors and the combining lenses) in the laser projection apparatus 1000 for light with different polarization directions. For example, the transmittance of an optical lens to the first linearly polarized light is greater than the transmittance of the optical lens to the second linearly polarized light.

Therefore, by using the first polarization conversion component 31 to convert the second linearly polarized light emitted by the second light-emitting group 120 into the first linearly polarized light, and by using the second polarization conversion component 32 to convert the second linearly polarized light emitted by the third light-emitting group 130 into the first linearly polarized light, the polarization directions of the laser beams may be same, so as to avoid a problem of color blocks in the projection image due to the different transmission and reflection efficiency of the optical lenses for different polarized light.

The above description is mainly given by considering an example in which the laser source 1 includes two polarization conversion components, but the present disclosure is not limited thereto. In some embodiments, the laser source 1 may include one polarization conversion component.

FIG. 12 is a diagram showing a beam path of another laser source corresponding to the laser device shown in FIG. 8. As shown in FIG. 12, the laser source 1 includes a third polarization conversion component 33. The third polarization conversion component 33 is located on the laser-exit side of the first light-emitting sub-group 1101 and configured to adjust a polarization of the incident laser beam, so that the first linearly polarized light may be converted into the second linearly polarized light. In this case, the beam path corresponding to the combining lens group 200 and the light-emitting group 140 included in the laser source 1 is the same as the relevant content described above, and details will not be repeated herein.

Here, by providing one polarization conversion component, the number of optical elements in the laser projection apparatus 1000 may be reduced, and the volume of the laser projection apparatus 1000 may be reduced. Moreover, the loss of the laser beam during propagation in the optical elements may be reduced by reducing the optical elements through which the laser beam passes, thereby improving the optical efficiency of the laser projection apparatus 1000.

In some embodiments of the present disclosure, two laser beams of a same color emitted by the first light-emitting sub-group 1101 and the second light-emitting sub-group 1102 may be combined by the first combining lens group 201, so that the beam spots corresponding to the first light-emitting sub-group 1101 and the second light-emitting sub-group 1102 may be approximately at a same position.

Moreover, the laser beams emitted by the second light-emitting group 120 and the third light-emitting group 130 may be combined by the second combining lens group 202, so that the beam spots of the second light-emitting group 120 and the third light-emitting group 130 may be approximately at a same position.

Finally, the laser beam combined by the first combining lens group 201 may be combined by the third combining lens group 203 with the laser beam combined by the second combining lens group 202, so that the beam spots of the first laser beam emitted by the first light-emitting sub-group 1101, the first laser beam emitted by the second light-emitting sub-group 1102, the second laser beam emitted by the second light-emitting group 120, and the third laser beam emitted by the third light-emitting group 130 may be approximately at a same position, so as to reduce the size of the beam spot combined by the laser beams of the plurality of colors.

In some embodiments, the first light-emitting components 11 in the first light-emitting sub-group 1101 and the second light-emitting sub-group 1102 may be red laser chips or blue laser chips.

For example, in a case where the first light-emitting components 11 are red laser chips, one of the second light-emitting components 12 and the third light-emitting components 13 is a blue laser chip, and another of the second light-emitting components 12 and the third light-emitting components 13 is a green laser chip. Alternatively, in a case where the first light-emitting components 11 are blue laser chips, one of the second light-emitting components 12 and the third light-emitting components 13 is a red laser chip, and another of the second light-emitting components 12 and the third light-emitting components 13 is a green laser chip.

In the above description of the embodiments, specific features, structures, materials, or characteristics may be combined in a suitable manner in any one or more embodiments or examples.

A person skilled in the art will understand that the scope of disclosure in the present disclosure is not limited to specific embodiments discussed above and may modify and substitute some elements of the embodiments without departing from the spirits of the present disclosure. The scope of the present disclosure is limited by the appended claims.

What is claimed is:

1. A laser projection apparatus, comprising:
a laser source configured to provide illumination beams, and the laser source including:
a laser device including:
a plurality of first light-emitting components configured to emit a first laser beam;
a plurality of second light-emitting components configured to emit a second laser beam; and
a plurality of third light-emitting components configured to emit a third laser beam; wherein the plurality of first light-emitting components, the plurality of second light-emitting components, and the plurality of third light-emitting components each are arranged in an array, so as to provide a light-emitting group;
a combining lens group located on a laser-exit side of the laser device and configured to combine the laser beams of different colors emitted by the light-emitting group to a same position and propagate the combined laser beam in a preset direction; and
a polarization conversion component located on the laser-exit side of the laser device and configured to change a polarization direction of a portion of the laser beam of at least one color, so that the laser beam of the at least one color has different polarization directions;
a light modulation assembly configured to modulate the illumination beams with image signals, so as to obtain projection beams; and the light modulation assembly including:
a fly-eye lens group located on a laser-exit side of the laser source and configured to homogenize the incident laser beam; and
a light modulation device configured to modulate the illumination beams to obtain the projection beams; and
a projection lens configured to project the projection beams into an image.

2. The laser projection apparatus according to claim 1, wherein wavelengths of the first laser beam, the second laser beam, and the third laser beam are different from each other, and the light-emitting group includes a first light-emitting group, a second light-emitting group, and a third light-emitting group;
the plurality of first light-emitting components are arranged in an array, so as to provide the first light-emitting group, and the first light-emitting group is configured to emit the first laser beam;
the plurality of second light-emitting components are arranged in an array, so as to provide the second light-emitting group, and the second light-emitting group is configured to emit the second laser beam; and
the plurality of third light-emitting components are arranged in an array, so as to provide the third light-emitting group, and the third light-emitting group is configured to emit the third laser beam;
wherein a size of a beam spot combined by the combining lens group matches Etendue of the fly-eye lens group.

3. The laser projection apparatus according to claim 2, wherein the combining lens group includes:
a first combining lens group configured to combine the first laser beam emitted by the first light-emitting group with the laser beam emitted by one of the second light-emitting group and the third light-emitting group; and
a second combining lens group configured to combine the laser beam combined by the first combining lens group with the laser beam emitted by another of the second light-emitting group and the third light-emitting group.

4. The laser projection apparatus according to claim 3, wherein
the first light-emitting group includes a first light-emitting sub-group and a second light-emitting sub-group; and
the first light-emitting sub-group and the second light-emitting sub-group are arranged in a row along a first direction, and the second light-emitting group and third light-emitting group are arranged in another row along the first direction.

5. The laser projection apparatus according to claim 4, wherein the first light-emitting sub-group and the second light-emitting group are arranged in at least one column along a second direction, and the second light-emitting sub-group and the third light-emitting group are arranged in at least one column along the second direction; the first direction is perpendicular to the second direction; and
a number of rows in an array provided by the first light-emitting group is equal to a number of rows in an array provided by the second light-emitting group and the third light-emitting group, and a number of columns in the array provided by the first light-emitting group is equal to a number of columns in the array provided by the second light-emitting group and the third light-emitting group.

6. The laser projection apparatus according to claim 4, wherein
the first combining lens group includes:
a first reflector located on a laser-exit side of the first light-emitting group and configured to reflect the first laser beam; and
a first combining lens located on laser-exit sides of the third light-emitting group and the first reflector and configured to reflect the third laser beam and transmit the first laser beam;
the second combining lens group includes:
a second reflector located on a laser-exit side of the second light-emitting group and configured to reflect the second laser beam;
a third reflector located on a laser-exit side of the second reflector and configured to reflect the second laser beam; and
a second combining lens located on laser-exit sides of the first combining lens and the third reflector and configured to transmit the second laser beam and reflect the first laser beam and the third laser beam.

7. The laser projection apparatus according to claim 4, wherein
the first combining lens group includes:
a first reflector located on a laser-exit side of the first light-emitting group and configured to reflect the first laser beam; and
a first combining lens located on laser-exit sides of the second light-emitting group and the first reflector and configured to reflect the second laser beam and transmit the first laser beam;
the second combining lens group includes:
a second reflector located on a laser-exit side of the third light-emitting group and configured to reflect the third laser beam;
a third reflector located on a laser-exit side of the first combining lens and configured to reflect the first laser beam and the second laser beam; and
a second combining lens located on laser-exit sides of the second reflector and the third reflector and configured to transmit the first laser beam and the second laser beam, and reflect the third laser beam.

8. The laser projection apparatus according to claim 4, wherein
the first light-emitting components are configured to emit one of a green laser beam, a blue laser beam, and a red laser beam;
the second light-emitting components are configured to emit another of the green laser beam, the blue laser beam, and the red laser beam; and
the third light-emitting component are configured to emit yet another of the green laser beam, the blue laser beam, and the red laser beam.

9. The laser projection apparatus according to claim 4, wherein
the first light-emitting components are configured to emit a red laser beam;
the second light-emitting components are configured to emit one of a green laser beam and a blue laser beam; and
the third light-emitting components are configured to emit another of the green laser beam and the blue laser beam.

10. The laser projection apparatus according to claim 2, wherein the first light-emitting group includes a first light-emitting sub-group and a second light-emitting sub-group, and the combining lens group includes:
a first combining lens group configured to combine the first laser beams emitted by the first light-emitting sub-group and the second light-emitting sub-group;
a second combining lens group configured to combine the laser beams emitted by the second light-emitting group and the third light-emitting group; and
a third combining lens group configured to combine the laser beam combined by the first combining lens group with the laser beam combined by the second combining lens group.

11. The laser projection apparatus according to claim 10, wherein
the second light-emitting group and the first light-emitting sub-group are arranged in a row along a first direction, the third light-emitting group and the second light-emitting sub-group are arranged in another row along the first direction, the first light-emitting sub-group and the second light-emitting sub-group are arranged in at least one column along a second direction, the second light-emitting group and the third light-emitting group are arranged in at least one column along the second direction, and the first direction is perpendicular to the second direction.

12. The laser projection apparatus according to claim 11, wherein
a number of rows in an array provided by the first light-emitting sub-group and the second light-emitting group is equal to a number of rows in an array provided by the second light-emitting sub-group and the third light-emitting group, and a number of columns in the array provided by the first light-emitting sub-group and the second light-emitting group is equal to a number of columns in the array provided by the second light-emitting sub-group and the third light-emitting group.

13. The laser projection apparatus according to claim 11, wherein
the first laser beams emitted by the first light-emitting sub-group and the second light-emitting sub-group are a first linearly polarized light, the second laser beam emitted by the second light-emitting group and the third laser beam emitted by the third light-emitting group are a second linearly polarized light, and polarization directions of the first linearly polarized light and the second linearly polarized light are perpendicular to each other; and
the polarization conversion component is further configured to adjust the polarization direction of the incident laser beam, so that the first linearly polarized light is converted into the second linearly polarized light, and the second linearly polarized light is converted into the first linearly polarized light.

14. The laser projection apparatus according to claim 13, wherein the polarization conversion component includes:
a first polarization conversion component located on laser-exit sides of the first light-emitting sub-group and the second light-emitting group, the first polarization conversion component being configured to adjust the polarization direction of the incident laser beam, so that the first linearly polarized light is converted into the second linearly polarized light, and the second linearly polarized light is converted into the first linearly polarized light; and
a second polarization conversion component located on a laser-exit side of the third light-emitting group, and the second polarization conversion component being configured to adjust the polarization direction of the incident laser beam, so that the second linearly polarized light is converted into the first linearly polarized light.

15. The laser projection apparatus according to claim 13, wherein the polarization conversion component includes:
a third polarization conversion component located on a laser-exit side of the first light-emitting sub-group and configured to adjust the polarization direction of the incident laser beam, so that the first linearly polarized light is converted into the second linearly polarized light.

16. The laser projection apparatus according to claim 13, wherein
the first combining lens group includes:
a first portion of a first reflector located on a laser-exit side of the first light-emitting sub-group and configured to reflect the first laser beam; and
a polarization combining lens located on laser-exit sides of the second light-emitting sub-group and the first portion of the first reflector, and the polarization combining lens being configured to transmit the second linearly polarized light and reflect the first linearly polarized light;
the second combining lens group includes:
a second portion of the first reflector located on a laser-exit side of the second light-emitting group and configured to reflect the second laser beam; and
a first combining lens located on a laser-exit side of the third light-emitting group and the laser-exit side of the second portion of the first reflector, and the first combining lens being configured to reflect the third laser beam and transmit the second laser beam;
the third combining lens group includes:
a second reflector located on a laser-exit side of the first combining lens and configured to reflect the second laser beam and the third laser beam; and
a second combining lens located on laser-exit sides of the second reflector and the polarization combining lens, and the second combining lens being configured to transmit the second laser beam and the third laser beam, and reflect the first laser beam.

17. The laser projection apparatus according to claim 16, satisfying one of following:
the first light-emitting components are configured to emit a red laser beam, one of the second light-emitting components and the third light-emitting components is configured to emit a blue laser beam, and another of the second light-emitting components and the third light-emitting components is configured to emit a green laser beam; and
the first light-emitting components are configured to emit the blue laser beam, one of the second light-emitting components and the third light-emitting components is configured to emit the red laser beam, and another of the second light-emitting components and the third light-emitting components is configured to emit the green laser beam.

18. The laser projection apparatus according to claim 2, wherein
the first light-emitting group includes a first light-emitting sub-group and a second light-emitting sub-group; an arrangement direction of the first light-emitting sub-group and the second light-emitting sub-group is perpendicular to an arrangement direction of the first light-emitting sub-group and the second light-emitting group and an arrangement direction of the second light-emitting sub-group and the third light-emitting group.

19. The laser projection apparatus according to claim 1, wherein the light modulation assembly further includes a first light homogenizing component located on the laser-exit side of the laser source, and the first light homogenizing component is configured to homogenize and diffuse the illumination beams from the laser source.

20. The laser projection apparatus according to claim 19, wherein the light modulation assembly further includes:
a beam shaping assembly located on a laser-exit side of the first light homogenizing component, the beam shaping assembly being configured to converge the illumination beams diffused by the first light homogenizing component, the fly-eye lens group being located on a laser-exit side of the beam shaping assembly; and
a lens assembly located on a laser-exit side of the fly-eye lens group and configured to propagate the illumination beams to the light modulation device.
